(19) United States
(12) Patent Application Publication
(10) Pub. No.: US 2014/0153855 A1
(43) Pub. Date: Jun. 5, 2014

(54) Rolling Bearing Having Insulating Material

(71) Applicants: Thierry Adane, Tours (FR); Stephane Cordier, Tours (FR)

(72) Inventors: Thierry Adane, Tours (FR); Stephane Cordier, Tours (FR)

(21) Appl. No.: 14/118,507

(22) PCT Filed: May 16, 2011
(86) PCT No.: PCT/EP2011/057880

§ 371 Date: Feb. 24, 2014

(51) Int. Cl. F16C 33/62; F16C 33/66

(52) U.S. Cl. CPC F16C 33/62; F16C 33/6651
USPC 384/473; 384/569; 384/513

(57) ABSTRACT

A rolling bearing comprising an inner ring, an outer ring, at least one row of rolling elements between the inner and outer rings, and an annular housing comprising at least one part surrounding at least one of the rings, said outer ring comprising two separate parts, each of the two parts of said outer ring defining one closed space with the housing. At least one part forming said housing or said outer ring has a sandwich structure with an inner layer made of a damping material and two outer layers made of a metallic material surrounding the inner layer.

### CROSS REFERENCE TO RELATED APPLICATION

This application is a National Stage application claiming the benefit of International Application Number PCT/EP2011/057880 filed on 16 May 2011.

### FIELD OF THE INVENTION

The present invention relates to rolling bearings, in particular to rolling bearings having an inner ring and an outer ring with one or more rows of rolling elements held by a cage between raceways provided in the two rings. The rolling elements may, for example, be balls. The rolling bearings may be, for example, those used in industrial electric motors or in motor vehicle gearboxes. In such applications, shaft voltage is usually generated between both ends of a rotary shaft, between the rotary shaft and each bearing. This shaft voltage is generated due to various reasons, such as, magnetic unbalance, static storage, induced electricity generated in the shaft. Excessive generation of this shaft voltage causes current of low frequency to flow through each bearing, through a bearing to the motor frame and back to the rotor through the opposite bearing resulting in wear in the bearings, damage to the rotary shaft, and blackening of lubricating oil, or in some cases, damage to bearings.

### BRIEF DESCRIPTION OF THE PRESENT INVENTION

One aim of the present invention is therefore to overcome the aforementioned drawbacks.

It is a particular object of the present invention to provide a rolling bearing of simple design, that is easy to assemble, economical, and which is electrically insulated.

It is also an object of the present invention to provide a rolling bearing having a good noise damping properties.

In one embodiment, a rolling bearing comprises an inner ring, an outer ring, at least one row of rolling elements between the inner and outer rings, and an annular housing comprising at least one part surrounding at least one of the rings, said outer ring comprising two separate parts. Each of the two parts of said outer ring defining one closed space with the housing.

At least one part forming said housing or said outer ring has a sandwich structure with an inner layer made of a damping material and two outer layers made of a metallic material surrounding the inner layer.

The use of a sandwich structure is aimed to significantly damp the noise created during the operation of the bearing.

In a first embodiment, only the outer ring has said sandwich structure and the housing is manufactured by cutting and pressing a metal sheet.

In a second embodiment, only the housing has said sandwich structure and the outer ring is manufactured by cutting and pressing a metal sheet.

In another embodiment, both the housing and the outer ring have said sandwich structure.

Advantageously, the damping material has electric insulating properties, for example an elastomeric material such as a rubber material or a thermoplastic elastomer.

The housing can comprise two distinct parts for retaining the parts of said outer ring and fixing means for fixing the distinct parts together, said first part of the housing comprising an inner axial cylindrical portion for retaining radially said outer ring and said second part of the housing comprising an outer axial cylindrical portion surrounding said inner axial cylindrical portion.

The first part of the housing can comprise a radial flange extending radially from the inner axial cylindrical portion towards the inner ring and defining with one of the parts of the outer ring a first closed space.

The second part of the housing can comprise a radial flange extending radially from the outer axial cylindrical portion towards the inner ring and defining with one of the parts of the outer ring a second closed space.

For example, both closed spaces contain a lubricant and act as lubricant reservoirs.

Advantageously, each of said separate parts of the outer ring comprises passage means for the lubricant contained in the closed spaces.

The fixing means can comprise welds or brazing or glue.

### BRIEF DESCRIPTION OF THE DRAWINGS

The present invention will be better understood from studying the detailed description of a number of embodiments considered by way of entirely non-limiting examples and illustrated by the attached drawings in which:

FIG. 1 is an axial half-section of the rolling bearing according to the invention, in a first embodiment;

FIG. 2 is an axial half-section of a second embodiment;

FIG. 3 is an axial half-section of a third embodiment;

FIG. 4 is an axial half-section of a fourth embodiment;

FIG. 5 is an axial half-section of a fifth embodiment;

FIG. 6 is an axial half-section of a sixth embodiment.

### DETAILED DESCRIPTION OF THE PRESENT INVENTION

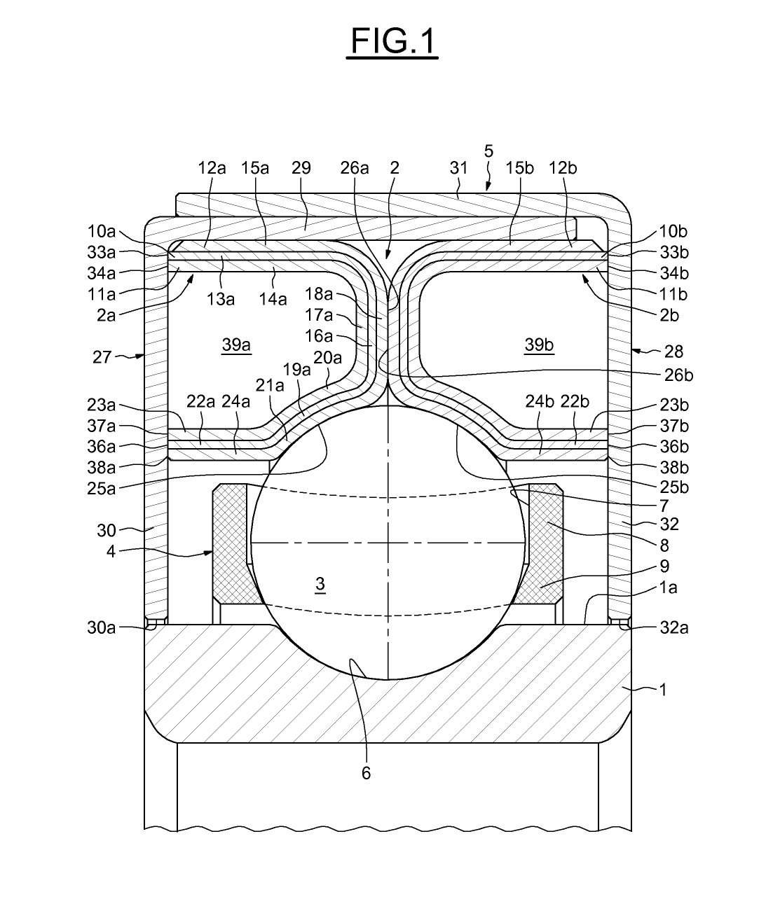

Referring first to FIG. 1, which illustrates an embodiment of a rolling bearing according to the invention; said bearing comprises an inner ring 1, an outer ring 2, a row of rolling elements 3 consisting, in the example illustrated, of balls, held by a cage 4 between the inner ring 1 and the outer ring 2, and an annular housing 5 surrounding the outer ring 2.

The inner ring 1 is solid and has on its outer cylindrical surface 1a a toroidal groove 6, the radius of curvature of which is slightly greater than the radius of the rolling elements 3 and forms a bearing race for the rolling elements 3. The rolling elements 3 can be, for example, made of a ceramic material. The inner ring 1 may be manufactured by machining or by pressing a steel blank, which is then ground and optionally lapped at the bearing race 6 in order to give the ring 1 its geometrical characteristics and its final surface finish.

The cage 4 comprises a plurality of cavities 7 designed to house the rolling elements 3 and keep them uniformly circumferentially spaced. The cavities 7 are advantageously of spherical shape with a diameter slightly greater than that of the rolling elements 3. The cavities 7 are provided in the radial thickness of the cage 4 having a radial portion 8 radially facing the outer ring 2 and extending radially inwards by a conical portion 9. The conical portion 9 is located radially facing the inner ring 1 and extends axially towards the rolling elements 3. The radial portion 8 and the conical portion 9 define the cavities 7. The conical portion 9 forms a guide portion for the rolling elements 3.

In this embodiment, the outer ring 2 comprises two separate parts 2a, 2b or half rings. The two parts 2a, 2b of the outer ring 2 are identical and symmetric with respect to the radial symmetry plane of the bearing in order to reduce manufacturing costs. Since the two half-rings 2a, 2b are identical in this example, only one of them, having the reference “a” will be described here, it being understood that the identical elements of the other half-ring 2b bear the reference “b” in the figure.

The half-ring 2a of the outer ring 2 has a sandwich structure with an inner layer 10a made of a damping material having good insulating properties and two outer layers 11a, 12a surrounding the inner layer 10a. The damping material used can be an elastomeric material, such as a rubber material or a thermoplastic elastomer. Said outer layers 11a, 12a are made of a rigid metallic material. Each of the three layers 10a, 11a, 12a, forming the half-ring 2a of the outer ring 2, comprises an outer axial portion 13a, 14a, 15a, a radial portion 16a, 17a, 18a, a toroidal portion 19a, 20a, 21a and an inner axial portion 22a, 23a, 24a. The radial portions 16a, 17a, 18a connects to the outer axial portions 13a, 14a, 15a and to the toroidal portions 19a, 20a, 21a. The toroidal portion 20a of the first outer layer 11a defines part of a raceway 25a for the rolling elements 3. The radius of curvature of the raceway 25a slightly exceeds the radius of the rolling elements 3. The toroidal portions 19a, 20a, 21a extends axially towards the outside of the bearing with an inner axial portions 22a, 23a, 24a. The two outer half-rings 2a, 2b are arranged with the radial internal faces 26a, 26b of the radial portions 18a, 18b of the outer layers 12a, 12b in axial contact with one another, substantially in the radial symmetry plane of the rolling elements 3.

The housing 5, which is advantageously made of a stamped metal sheet, comprises two distinct annular parts 27, 28 enclosing the two outer half-rings 2a, 2b so as to hold them firmly together in the axial direction. The parts 27, 28 of the housing 5 may advantageously be produced in an economical way from a single metal sheet by cutting and pressing. Each distinct part 27, 28 have an L-shaped structure. Alternatively, the housing 5 can be made of rigid polymer material.

The first part 27 comprises an inner axial cylindrical portion 29 for retaining radially said outer rings 2a, 2b. The inner axial cylindrical portion 29 surrounds the outer rings 2a, 2b and is in contact with the outer axial portions 15a, 15b of the second outer layers 12a, 12b of the outer rings 2a, 2b. The first part 27 further comprises a radial flange 30 extending radially from the inner axial cylindrical portion 29 towards the immediate vicinity of the outer cylindrical surface 1a of the inner ring 1, so as to leave a clearance between the inner edge 30a of the radial flange 30 and the cylindrical surface 1a of the inner ring 1.

The second part 28 of the housing 5 comprises an outer axial cylindrical portion 31 surrounding the inner axial cylindrical portion 29 of the first part 27. The second part 28 further comprises a radial flange 32 extending radially from the outer cylindrical portion 31 towards the immediate vicinity of the outer cylindrical surface 1a of the inner ring 1, so as to leave a clearance between the inner edge 32a of the radial flange 32 and the cylindrical surface 1a of the inner ring 1.

The half-rings 2a, 2b are centred in the inner axial portion 29 of the part first 27 of the housing 5 by contact between the outer axial portions 15a, 15b of the second outer layers 12a, 12b and the bore of the said inner axial portion 29. The outer radial faces 33a, 34a, which form the outer edges respectively of the outer axial portions 13a, 14a are in contact with the radial flange 30 of the part 27 of the housing 5, and the outer radial faces 33b, 34b, which form the outer edges respectively of the outer axial portions 10b, 11b are in contact with the radial flange 32 of the part 28 of the housing 5, thus axially clamping the two half-rings 2a, 2b together. The outer radial faces 36a, 37a, 38a which form the outer edges respectively of the inner axial portions 22a, 23a, 24a are also in contact with the radial flange 30, and the outer radial faces 36b, 37b, 38b which form the outer edges respectively of the inner axial portions 22b, 23b, 24b are also in contact with the radial flange 32.

As an alternative, an axial clearance (not shown) may be provided between the outer edges 36a, 37a, 38a of the inner axial portions 22a, 23a, 24a and the radial flange 30 of the housing 5.

As an alternative, an axial clearance (not shown) may be provided between the outer edges 36b, 37b, 38b of the inner axial portions 22b, 23b, 24b and the radial flanges 32 of the housing 5.

Each of the half-rings 2a, 2b defines, with the housing 5, an annular closed space 39a, 39b. More specifically, the closed space 39a is delimited by the outer axial portion 14a, the radial portion 17a, the toroidal portion 20a, and the inner axial portion 23a of the first outer layer 11a, and, adjacent to these portions, the radial flange 30 of the first part 27 of the housing 5. One of the two or both spaces 39a, 39b may act as a lubricant reservoir, the lubricant contained in these spaces 39a, 39b not being depicted in the figures. The lubricant used may be grease or oil. Lubricant can be packed into the space 39a which constitutes a first lubricant reservoir between the half-ring 2a and the inner ring 1. Lubricant is also packed into the second space 39b and into the volume remaining between the inner 1 and outer 2 rings.

Each part 2a, 2b of the outer ring 2 comprises passage means (not illustrated in the figures) for the lubricant contained in the closed spaces 39a, 39b. These passage means can be of several types. First, these passage means can comprise a plurality of radial through-holes provided the thickness of the inner axial portions 22a, 23a, 24a and 22b, 23b, 24b of the outer half-rings 2a, 2b respectively. This arrangement of the holes allows the lubricant contained in the closed spaces 39a, 39b to flow by gravity directly towards the rolling elements 3. Further a plurality of axial through-holes can be provided the thickness of the radial portions 16a, 17a, 18a at least partially facing one another, so as to put the two closed spaces 39a, 39b into communication. As an alternative, each inner radial face 26a, 26b of the corresponding radial portion 18a, 18b can be provided with a radial groove (not shown) forming a radial passage or duct so that the outer end of the radial duct is in communication with the corresponding axial through-hole and its inner end is in communication with the toroidal race 25a, 25b so as to guide the lubricant directly onto the balls 3. In this example, it should be understood that the axial through-holes associated with a radial duct can easily not be located facing one another.

The outer axial cylindrical portion 31 is fixed to the inner axial cylindrical portion 29 by means of welding, brazing or glue.

In this embodiment, the inner radial faces 26a, 26b of the radial portions 18a, 18b of the second outer layers 12a, 12b are in contact with one another. This contact between the radial portions 18a, 18b makes it possible to obtain the rolling bearing with internal preload. Of course, as an alternative, an axial clearance can be provided between the radial portions 18a, 18b of the second outer layers 12a, 21b, so that the rolling bearing can operate with no internal preload.

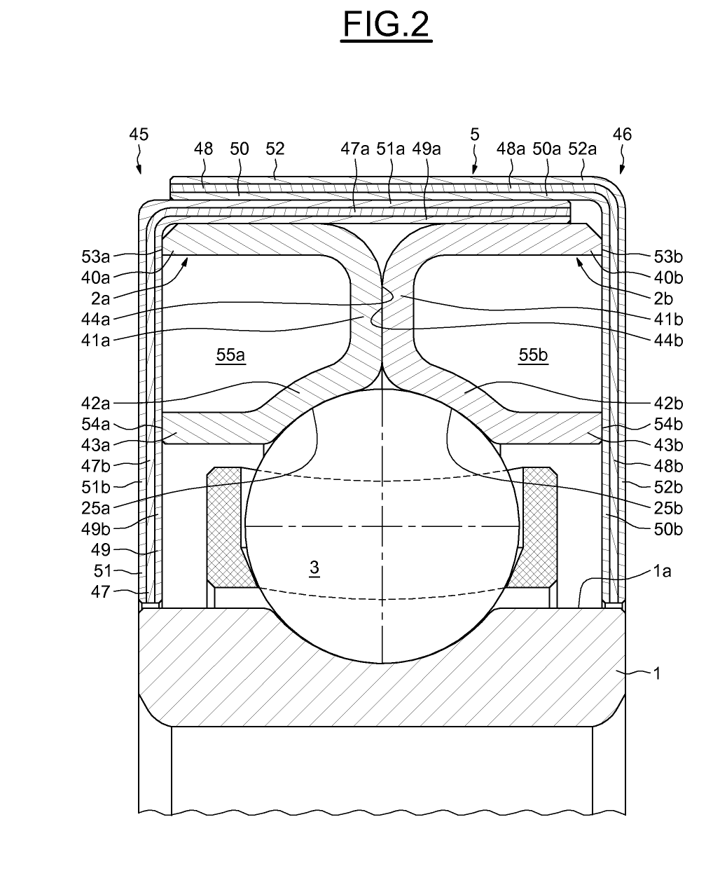

In the embodiment illustrated in FIG. 2, on which similar parts bear the same references, the two outer half-rings 2a, 2b may advantageously be manufactured by cutting and pressing a metal sheet, the components obtained then being hardened by heat treatment. The raceways intended for the rolling elements 3 may be ground and/or lapped in order to give them their definitive geometric characteristics and surface finish. Since the two half-rings 2a, 2b are identical in this example, only one of them, having the reference “a” will be described here, it being understood that the identical elements of the other half-ring 2b bear the reference “b” in the figure.

The half-ring 2a of the outer ring 2, comprises an outer axial portion 40a, a radial portion 41a, a toroidal portion 42a and an internal axial portion 43a. The radial portions 41a connect to the outer axial portions 40a and to the toroidal portions 42a. The toroidal portion 42a defines part of a raceway 25a for the rolling elements 3. The radius of curvature of the raceway 25a slightly exceeds the radius of the rolling elements 3. The toroidal portions 42a also connect to the inner axial portions 43a. The two outer half-rings 2a, 2b are arranged with the radial faces 44a, 44b of the radial portions 41a, 41b in axial contact with one another, substantially in the radial symmetry plane of the rolling elements 3.

The housing 5 comprises two distinct annular parts 45, 46 enclosing the two outer half-rings 2a, 2b so as to hold them firmly together in the axial direction. Each parts 45, 46 of the housing 5 has a sandwich structure having an inner layer 47, 48 made of a damping material, and two outer layers 49, 50, 51, 52 surrounding the inner layer 47, 48. Each distinct part 45, 46 have an L-shaped structure.

The three layers 47, 49, 51 of the first part 45 comprise each an inner axial cylindrical portion 47a, 49a, 51a for retaining radially said outer rings 2a, 2b. The inner axial cylindrical portion 49a of the first outer layer 49 surrounds the outer rings 2a, 2b and is in contact with the outer axial portions of the outer axial portions 40a, 40b of the outer rings 2a, 2b. The three layers 47, 49, 51 of the first part 45 further comprise a radial flange 47b, 49b, 51b extending radially from the inner cylindrical portions 47a, 49a, 51a towards the immediate vicinity of the outer cylindrical surface 1a of the inner ring 1, so as to leave a clearance between the inner edges of the radial flanges 47a, 49a, 51a and the cylindrical surface 1a of the inner ring 1.

The three layers 48, 50, 52 of the second part 46 of the housing 5 comprise each an outer axial cylindrical portion 48a, 50a, 52a surrounding the inner axial cylindrical portions 47a, 49a, 51a of the first part 45. The three layers 48, 50, 52 of the second part 46 further comprise a radial flange 48b, 50b, 52b extending radially from the outer cylindrical portion 48a, 50a, 52a towards the immediate vicinity of the outer cylindrical surface 1a of the inner ring 1, so as to leave a clearance between the inner edges of the radial flanges 48b, 50b, 52b and the cylindrical surface 1a of the inner ring 1.

The half-rings 2a, 2b are centred in the axial inner portion 49 of the first outer layer 49 of the first part 45 of the housing 5 by contact between the outer axial portions of the outer axial portions 40a, 40b and the bore of the said inner axial cylindrical portion 49a. The outer radial faces 53a, 53b which form the outer edges respectively of the outer axial portions 40a, 40b are respectively in contact with the radial flanges 49b, 50b of the first outer layers 49, 50 of the parts 45, 46 of the housing 5, thus axially clamping the two half-rings 2a, 2b together. The outer radial faces 54a, 54b which form the outer edges respectively of the inner axial portions 43a, 43b are also in contact with the radial flanges 49b, 50b.

As an alternative, an axial clearance (not shown) may be provided between the outer edges 54a, 54b of the inner axial portions 43a, 43b and the radial flanges 49, 50 respectively of the housing 5.

Each of the half-rings 2a, 2b defines, with the housing 5, an annular closed space 55a, 55b. More specifically, the closed space 55a is delimited by the outer axial portion 40a, the radial portion 41a, the toroidal portion 42a, and the inner axial portion 43a, and, adjacent to these portions, the radial flange 49b of the first outer layer 49 of the first part 45 of the housing 5. The lubricant used may be grease or oil. One of the two or both spaces 55a, 55b may act as a lubricant reservoir, the lubricant contained in these spaces 55a, 55b not being depicted in the figures. The lubricant used may be grease or oil. Lubricant can be packed into the space 55a which constitutes a first lubricant reservoir between the half-ring 2a and the inner ring 1. Lubricant is also packed into the second space 55b and into the volume remaining between the inner 1 and outer 2 rings. Passage means as described above can be provided on the outer ring 2.

The outer axial cylindrical portion 50a of the first outer layer 50 of the second part 46 is fixed to the inner axial cylindrical portion 51a of the second outer layer 51 of the first part 45 by means of welding, brazing or glue.

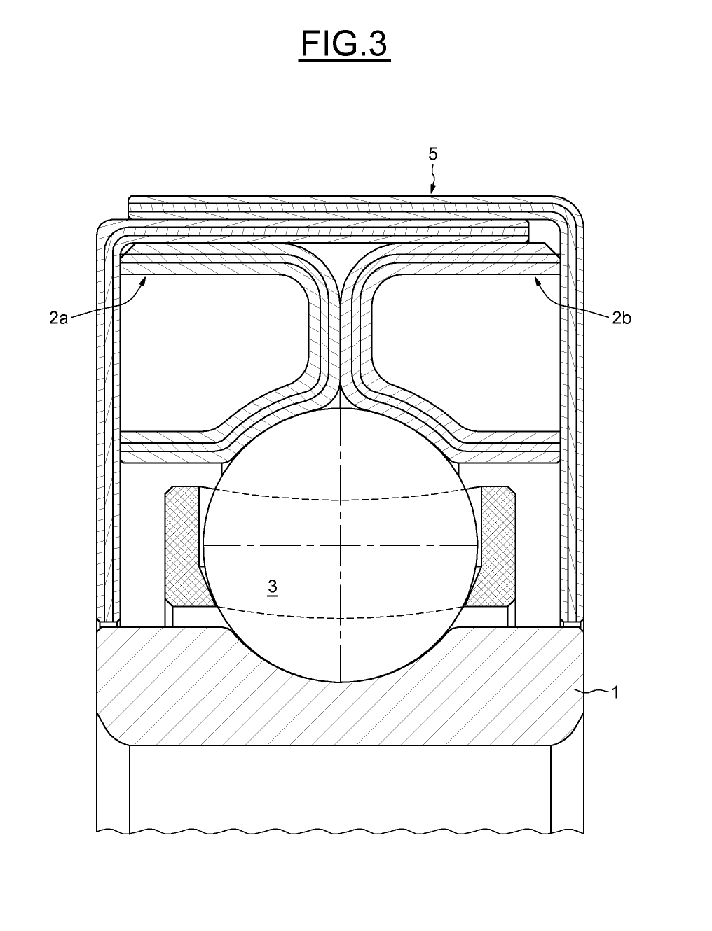

The specific features and characteristics mentioned for each of the embodiments of FIGS. 1 and 2 could be mixed in one embodiment as illustrated in FIG. 3, without major modification. In other words, it might be possible to have both the housing 5 and the outer ring 2 having a sandwich structure with an inner layer made of a damping material and two outer layers surrounding the inner layer as described in FIGS. 1 and 2.

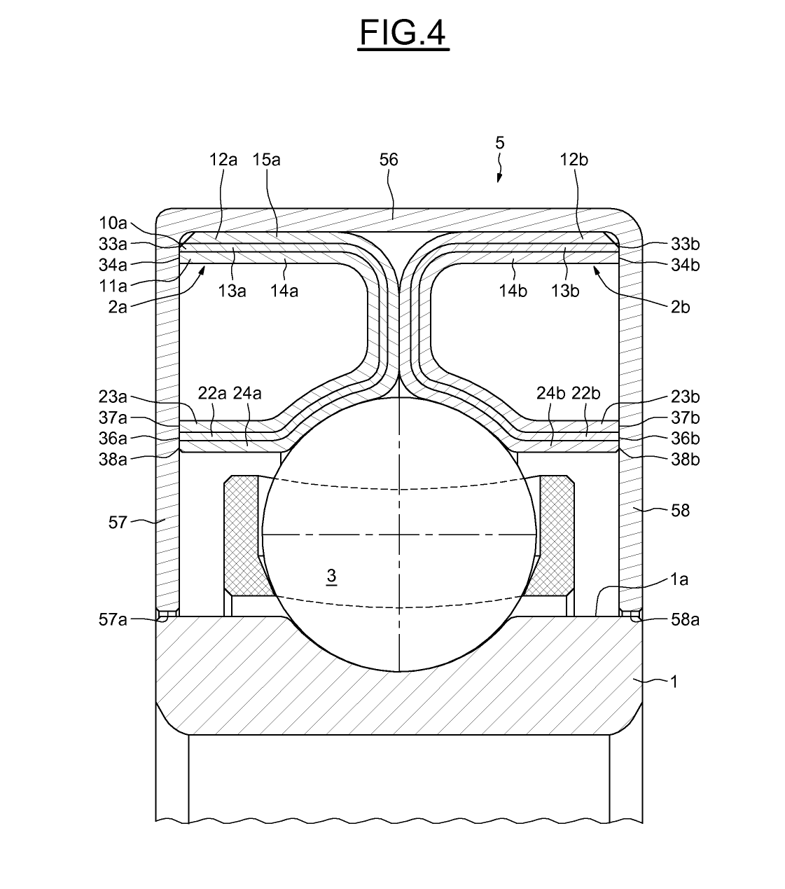

In the embodiment illustrated in FIG. 4, in which similar parts bear the same references as in FIG. 1, the bearing of FIG. 4 differs from the rolling bearing of FIG. 1, only in that the housing 5 comprises only one part, forming a U-shape. The housing 5, which is advantageously made of a stamped metal sheet, comprises only one annular part enclosing the two outer half-rings 2a, 2b so as to hold them firmly together in the axial direction. The housing 5 may advantageously be produced in an economical way from a single metal sheet by cutting and pressing. The housing 5 comprises an inner axial cylindrical portion 56 for retaining radially said outer rings 2a, 2b. The inner axial cylindrical portion 56 surrounds the outer rings 2a, 2b and is in contact with the outer axial portions 15a, 15b of the outer layers 12a, 12b of the outer rings 2a, 2b. The housing 5 further comprises two radial flanges 57, 58 extending radially from the inner cylindrical portion 56 towards the immediate vicinity of the outer cylindrical surface 1a of the inner ring 1, so as to leave a clearance between the inner edge 57a, 58a of the corresponding radial flange 57, 58 and the cylindrical surface 1a of the inner ring 1.

The half-rings 2a, 2b are centred in the inner axial portion 56 of the housing 5 by contact between the outer axial portions 15a, 15b of the second outer layers 12a, 12b and the bore of the said axial inner portion 56. The outer radial faces 33a, 34a which form the outer edges of the outer axial portions 13a, 14a are in contact with the radial flanges 57 of the housing 5, the outer radial faces 33b, 34b which form the outer edges of the outer axial portions 13b, 14b are in contact with the radial flanges 5_of the housing 5, thus axially clamping the two half-rings 2a, 2b together. The outer radial faces 36a, 37a, 38a which form the outer edges of the inner axial portions 22a, 23a, 24a are also in contact with the corresponding radial flange 57. The outer radial faces 36b, 37b, 38b which form the outer edges of the inner axial portions 22b, 23b, 24b are also in contact with the corresponding radial flange 58.

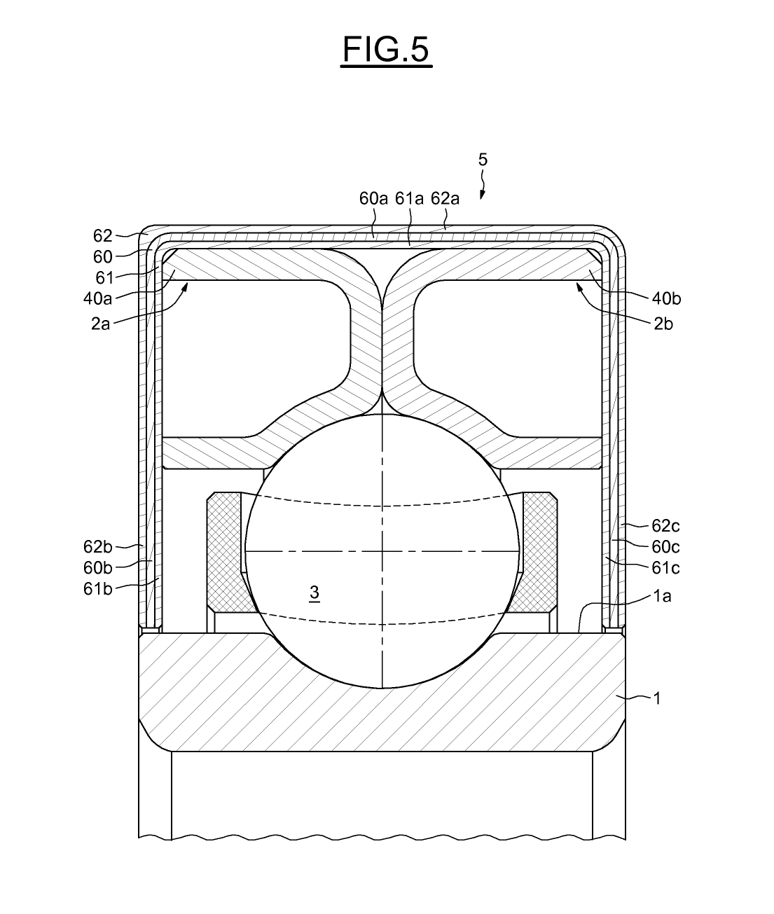

In the embodiment illustrated in FIG. 5, on which similar parts bear the same references as in FIG. 2, the bearing of FIG. 5 differs from the bearing of FIG. 2, only in that the housing 5 comprises only one part, forming a U-shape. The two outer half-rings 2a, 2b may advantageously be manufactured by cutting and pressing a metal sheet, the components obtained then being hardened by heat treatment and the housing 5 has a sandwich structure having an inner layer 60 made of a damping material, and two outer layers 61, 62 surrounding the inner layer 60.

The three layers 60, 61, 62 of the housing 5 comprise each an inner axial cylindrical portion 60a, 61a, 62a for retaining radially said outer rings 2a, 2b. The inner axial cylindrical portion 61a of the first outer layer 61 surrounds the outer rings 2a, 2b and is in contact with the outer axial portions 40a, 40b of the outer rings 2a, 2b. The three layers 60, 61, 62 of the housing 5 further comprise a radial flanges 60b, 60c, 61b, 61c, 62b, 62c extending radially from the inner axial cylindrical portions 60a, 61a, 62a towards the immediate vicinity of the outer cylindrical surface 1a of the inner ring 1, so as to leave a clearance between the inner edges of the radial flanges and the cylindrical surface 1a of the inner ring 1.

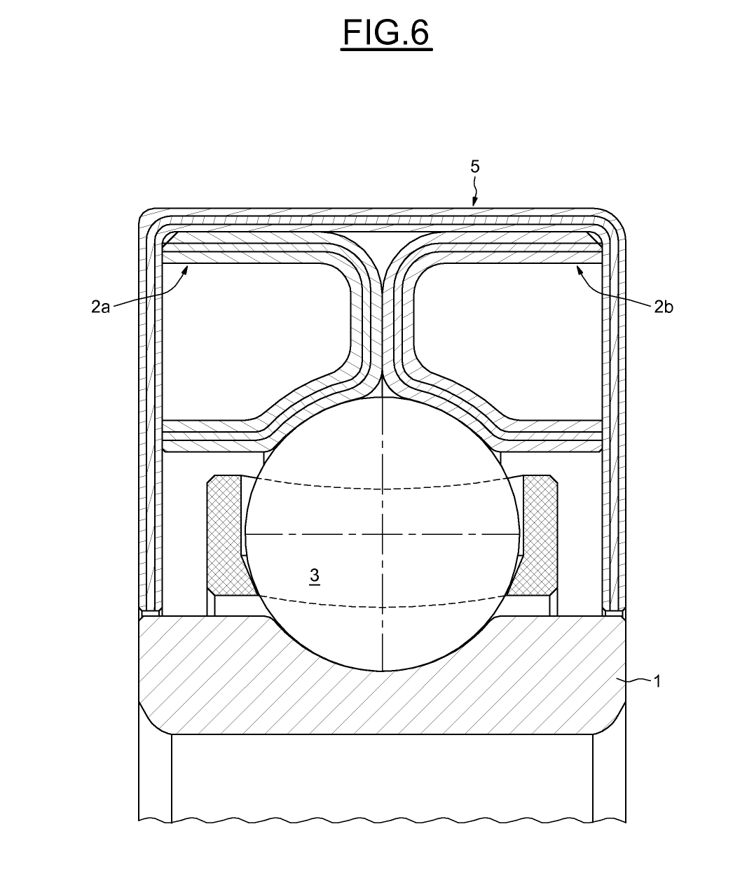

The specific features and characteristics mentioned for each of the embodiments of FIGS. 4 and 5 could be mixed in one embodiment as illustrated in FIG. 6, without major modification. In other words, it might be possible to have both the housing 5 having a U-shape and the outer ring 2 having a sandwich structure with an inner layer made of a damping material and two outer layers surrounding the inner layer as described in FIGS. 4 and 5.

Moreover, although the present invention has been illustrated using single-row ball bearings, it will be understood that the invention can be applied without major modification to bearings using rolling elements that are not balls and/or that have several rows of rolling elements.

Thanks to a sandwich structure, the rolling bearing according to the invention is electrically insulated and the noise produced by the bearing is damped.

1. A rolling bearing comprising an inner ring, an outer ring, at least one row of rolling elements between the inner and outer rings, and an annular housing comprising at least one part surrounding at least one of the rings, said outer ring comprising two separate parts, each of the two parts of said outer ring defining one closed space with the housing, characterized in that at least one part forming said housing or said outer ring has a sandwich structure with an inner layer made of a damping material and two outer layers made of a metallic material surrounding the inner layer.

2. The rolling bearing according to claim 1, in which only the outer ring has said sandwich structure and the housing is manufactured by cutting and pressing a metal sheet.

3. The rolling bearing according to claim 1, in which only the housing has said sandwich structure and the outer ring is manufactured by cutting and pressing a metal sheet.

4. The rolling bearing according to claim 1, in which both the housing and the outer ring have said sandwich structure.

5. The rolling bearing according to claim 1, in which the damping material has electric insulating properties.

6. The rolling bearing according to claim 1, in which the damping material is an elastomeric material.

7. The rolling bearing according to claim 1, in which the housing comprises two distinct parts for retaining the parts of said outer ring and fixing element for fixing the distinct parts together, said first part of the housing comprising an inner axial cylindrical portion for retaining radially said outer ring and said second part of the housing comprising an outer axial cylindrical portion surrounding said inner axial cylindrical portion.

8. The rolling bearing according to claim 7, in which the first part of the housing comprises a radial flange extending radially from the inner axial cylindrical portion towards the inner ring and defining with one of the parts of the outer ring a first closed space.

9. The rolling bearing according to claim 7, in which the second part of the housing comprises a radial flange extending radially from the outer axial cylindrical portion towards the inner ring and defining with one of the parts of the outer ring a second closed space.

10. The rolling bearing according to claim 7, in which both closed spaces contain a lubricant and act as lubricant reservoirs.

11. The rolling bearing according to claim 10, in which each of said separate parts of the outer ring comprises a fluid passageway for the lubricant contained in the closed spaces.

12. The rolling bearing according to claim 7, in which the fixing element comprises one of weld, brazing or glue.

13. A rolling bearing according to claim 6, in which the elastomeric material is one of a rubber material or a thermoplastic elastomer.

14. The rolling bearing according to claim 2, in which the damping material is an elastomeric material.

15. The rolling bearing according to claim 3, in which the damping material is an elastomeric material.

16. The rolling bearing according to claim 4, in which the damping material is an elastomeric material.

17. The rolling bearing according to claim 8, in which the second part of the housing comprises a radial flange extending radially from the outer axial cylindrical portion towards the inner ring and defining with one of the parts of the outer ring a second closed space.

18. The rolling bearing according to claim 8, in which both closed spaces contain a lubricant and act as lubricant reservoirs.

19. The rolling bearing according to claim 9, in which both closed spaces contain a lubricant and act as lubricant reservoirs.
